(19) United States
(12) Patent Application Publication
(10) Pub. No.: US 2026/0149497 A1
(43) Pub. Date: May 28, 2026

(54) APPARATUS AND METHODS OF BEAM MANAGEMENT FOR AN ACCESS LINK IN A NEW RADIO NETWORK-CONTROLLED REPEATER (NR-NCR)

(71) Applicant: INTERDIGITAL PATENT HOLDINGS, INC., Wilmington, DE (US)

(72) Inventors: Nazli KHAN BEIGI, Longueuil (CA); Young Woo KWAK, Woodbury, NY (US); Moon IL LEE, Melville, NY (US); Paul MARINIER, Brossard (CA); Prasanna HERATH, Laval (CA)

(73) Assignee: INTERDIGITAL PATENT HOLDINGS, INC., Wilmington, DE (US)

(21) Appl. No.: 19/123,298

(22) PCT Filed: Nov. 6, 2023
(86) PCT No.: PCT/US2023/078767

§ 371 Date: Apr. 22, 2025

Related U.S. Application Data
(60) Provisional application No. 63/423,994, filed on Nov. 9, 2022.

(51) Int. Cl. H04B 7/155; H04B 7/06; H04W 72/23

(52) U.S. Cl. CPC H04B 7/15542; H04B 7/0695; H04W 72/23

(57) ABSTRACT

A relay node may receive a pattern index indicating a beam pattern. Further, the relay node may receive resource information indicating a beam type. Also, the relay node may receive one or more first beam indexes associated with the indicated beam pattern. On a condition that the indicated beam type is narrow and a beam index of the one or more first beam indexes corresponds to a wide beam type, the relay node may determine second beam indexes for a set of narrow beams associated with the beam index of the one or more first beam indexes corresponding to the wide beam type. Moreover, the relay node may determine a beam and time-domain resources for each of the determined second beam indexes based on the pattern index and resource information. Accordingly, the relay node may transmit data using the determined beam and at least one of the determined time-domain resources.

### CROSS-REFERENCE TO RELATED APPLICATION

This application claims the benefit of U.S. Provisional Application No. 63/423,994, filed Nov. 9, 2022, the contents of which are incorporated herein by reference.

### BACKGROUND

Network-controlled repeaters (NCRs) may be an improved foundation for coverage enhancements in coverage holes, and coverage extension in networks. The NCR can be considered as a repeater node or relay node that can be configured via side control information (SCI) to perform further advanced operations, perform further smart operations, or both.

Beam management is one of the most important types of side-control information that may be used by NCRs. An NCR may communicate and forward SCI, signals or both, from a base station to a handset. The NCR may communicate with the base station via a control link, a backhaul link or both. Further, the NCR may communicate with the handset via an access link.

### SUMMARY

A relay node may receive a beam pattern index indicating a beam pattern Further, the relay node may receive resource information indicating a beam type. Also, the relay node may receive one or more first beam indexes associated with the indicated beam pattern. In an example, the relay node may be a network-controlled repeater (NCR). In another example, the relay node may be a wireless transmit/receive unit (WTRU).

On a condition that the indicated beam type is narrow and a beam index of the one or more first beam indexes corresponds to a wide beam type, the relay node may determine second beam indexes for a set of narrow beams associated with the beam index of the one or more first beam indexes corresponding to the wide beam type. Moreover, the relay node may determine a beam and time-domain resources for each of the determined second beam indexes based on the pattern index and the resource information. As a result, the relay node may transmit data using the determined beam and at least one of the determined time-domain resources.

In an example, the data may be DL data transmitted to a WTRU. In another example, the data may be transmitted over an access link. In a further example, the data may be sidelink data forwarded to the WTRU. In an additional or alternative example, the data may be side data forwarded to WTRU. In another example, the data may be uplink data transmitted to a base station. In an additional example, the data may be uplink data forwarded to a base station.

In an example, the received resource information may further indicate one or more of a starting time, a periodicity, a time granularity, a time window, or a beam direction. The beam direction may be uplink or may be downlink, in examples.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example of a model for network controlled repeaters (NCRs);

FIG. 3 is a system diagram illustrating an example of backhaul-link, control-link and access link beam resources;

FIG. 4 is a beam pattern diagram illustrating an example of hierarchical beams in an access link;

FIG. 5 is a beam pattern indication diagram illustrating an example of single-slot or multi-slot beam pattern indication;

FIG. 6 is a flow chart diagram illustrating an example of a procedure for beam management for an NCR;

FIG. 7 is a flow chart diagram illustrating an example of a procedure for beam management for a repeater node; and

FIG. 8 is a beam pattern diagram illustrating an example of an indication of spatial relation for adjacent access beams via a table of indexes.

### DETAILED DESCRIPTION

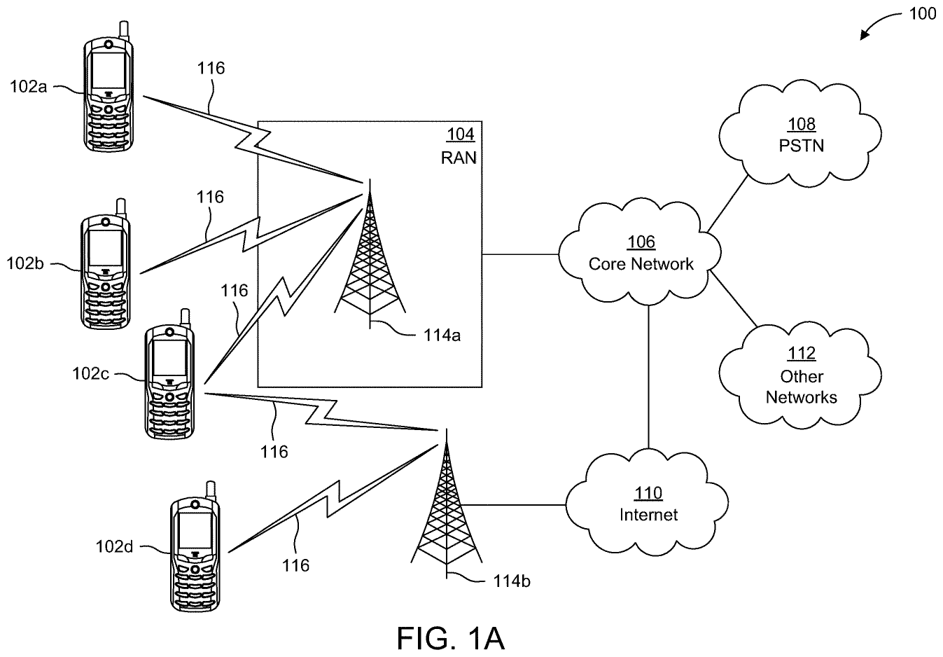

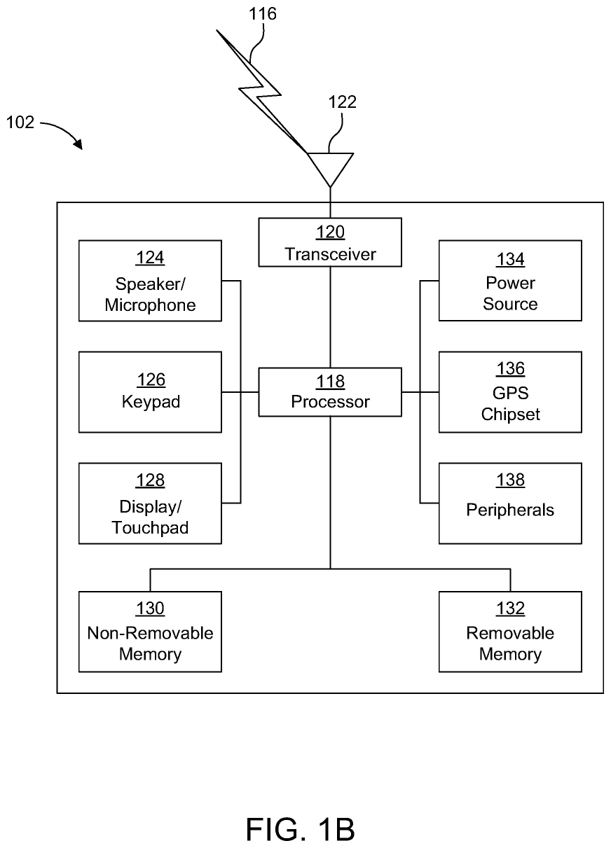

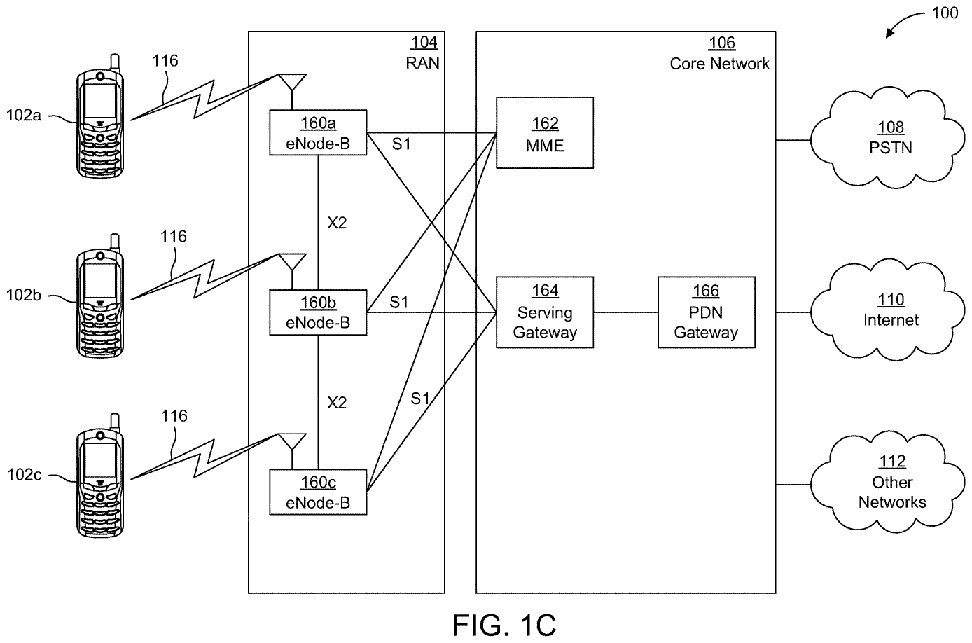

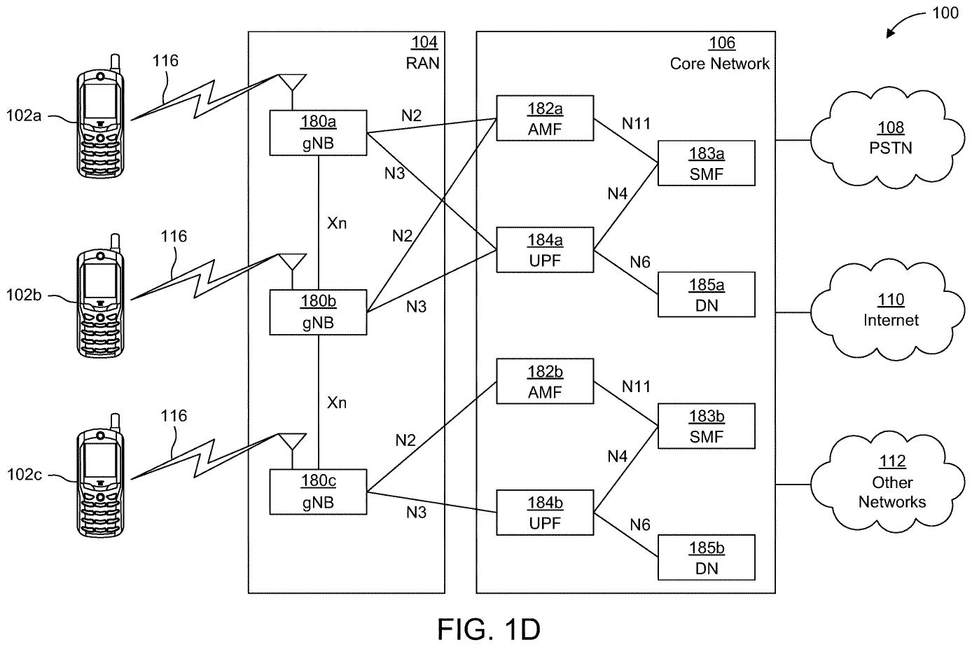

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

The following abbreviations and acronyms may be used in embodiments and examples provided herein:
Δf Sub-carrier spacing
gNB NR NodeB
AP Aperiodic
BFR Beam Failure Recovery
BFD-RS Beam Failure Detection-Reference Signal
BLER Block Error Rate
BWP Bandwidth Part
CA Carrier Aggregation
CB Contention-Based (e.g. access, channel, resource)
CCA Clear Channel Assessment
CDM Code Division Multiplexing
CG Cell Group
CLI Cross Link Interference
CoMP Coordinated Multi-Point transmission/reception
COT Channel Occupancy Time
CP Cyclic Prefix
CPE Common Phase Error
CP-OFDM Conventional OFDM (relying on cyclic prefix)
CQI Channel Quality Indicator
CN Core Network (e.g. LTE packet core or NR core)
CRC Cyclic Redundancy Check
CSI Channel State Information
CSI-RS Channel State Information-Reference Signal
CU Central Unit
D2D Device to Device transmissions (e.g. LTE Sidelink)
DC Dual Connectivity
DCI Downlink Control Information
DL Downlink
DM-RS Demodulation Reference Signal
DRB Data Radio Bearer
DU Distributed Unit
EN-DC E-UTRA-NR Dual Connectivity
EPC Evolved Packet Core
FD-CDM Frequency Domain-Code Division Multiplexing
FDD Frequency Division Duplexing
FDM Frequency Division Multiplexing
ICI Inter-Cell Interference
ICI Interference Configuration Indication
ICIC Inter-Cell Interference Cancellation
IP Internet Protocol
LBT Listen-Before-Talk
LCH Logical Channel
LCID Logical Channel Identity
LCP Logical Channel Prioritization
LLC Low Latency Communications
LTE Long Term Evolution, e.g., from 3GPP LTE R8 and up
MAC Medium Access Control
MAC CE Medium Access Control-Control Element
NACK Negative ACK
MBMS Multimedia Broadcast Multicast System
MCG Master Cell Group
MCS Modulation and Coding Scheme
MIMO Multiple Input Multiple Output
MTC Machine-Type Communications
MR-DC Multi-RAT Dual Connectivity
NAS Non-Access Stratum
NCB-RS New candidate beam-Reference Signal
NE-DC NR-RAN-E-UTRA Dual Connectivity
NR New Radio
NR-DC Dual Connectivity with
OFDM Orthogonal Frequency-Division Multiplexing
OOB Out-Of-Band (emissions)
P_{cmax} Total available WTRU power in a given transmission interval
Pcell Primary cell of Master Cell Group
PCG Primary Cell Group
PDU Protocol Data Unit
PER Packet Error Rate
PHY Physical Layer
PLMN Public Land Mobile Network
PLR Packet Loss Rate
PRACH Physical Random-Access Channel
PRB Physical Resource Block
PRS Positioning Reference Signal
Pscell Primary cell of a Secondary cell group
PSS Primary Synchronization Signal
PT-RS Phase Tracking-Reference Signal
QoS Quality of Service (from the physical layer perspective)
RAB Radio Access Bearer
RAN PA Radio Access Network Paging Area
RACH Random Access Channel (or procedure)
RAR Random Access Response
RAT Radio Access Technology
RB Resource Block
RCU Radio access network Central Unit
RF Radio Front end
RE Resource Element
RLF Radio Link Failure
RLM Radio Link Monitoring
RNTI Radio Network Identifier
RO Random Access Occasion
ROM Read-Only Mode (for MBMS)
RRC Radio Resource Control
RRM Radio Resource Management
RS Reference Signal
RTT Round-Trip Time
SCG Secondary Cell Group
SCI Side Control Information
SCMA Single Carrier Multiple Access
SCS Sub-Carrier Spacing
SDU Service Data Unit
SOM Spectrum Operation Mode
SP Semi-persistent
SpCell Primary cell of a master or secondary cell group.

SRB Signaling Radio Bearer
SS Synchronization Signal
SRS Sounding Reference Signal
SSS Secondary Synchronization Signal
SUL Supplementary UpLink
SWG Switching Gap (in a self-contained subframe)
TB Transport Block
TBS Transport Block Size
TCI Transmission Configuration Indicator
TDD Time-Division Duplexing
TDM Time-Division Multiplexing
TI Time Interval (in integer multiple of one or more symbols)
TTI Transmission Time Interval (in integer multiple of one or more symbols)
TRP Transmission/Reception Point
TRPG Transmission/Reception Point Group
TRS Tracking Reference Signal
TRx Transceiver
UL Uplink
URC Ultra-Reliable Communications
URLLC Ultra-Reliable and Low Latency Communications
V2X Vehicular communications
WLAN Wireless Local Area Networks and related technologies (IEEE 802.xx domain)
XDD Cross Division Duplex

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUS 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Network-controlled repeaters (NCRs) may be an improved foundation for coverage enhancements in coverage holes, and coverage extension in networks. The NCR can be considered as a repeater node or relay node that can be configured via control information, such as side control information (SCI), to perform further advanced operations, smart operations or both operations.

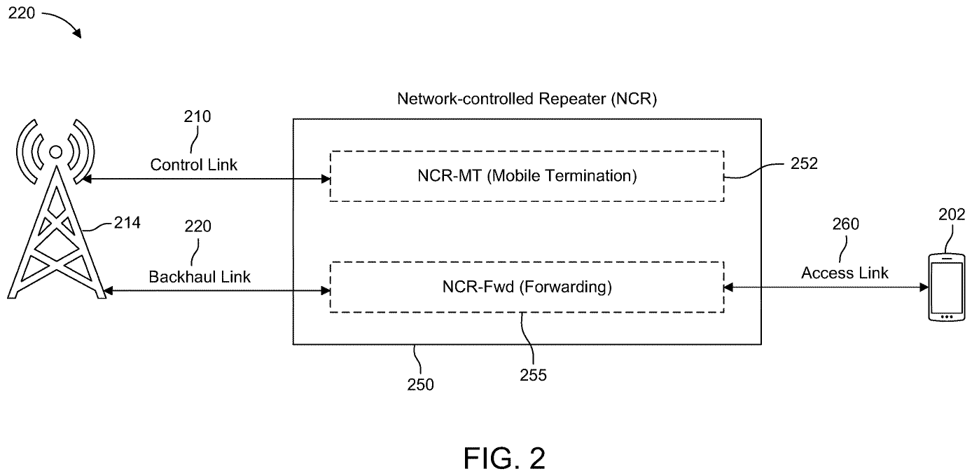

FIG. 2 is system diagram illustrating an example of a model for NCRs. As shown in an example in system diagram 200, the NCR-mobile termination (NCR-MT) 252 may be defined as a function entity within an NCR 250 to communicate with a gNB or a base station 214 via a Control link (C-link) 210 to enable the information exchanges. In an example, base station 214 may be the same as or similar to base station 114a or 114b. In another example, the information exchanges may include SCI. The C-link 210 is based on a NR Uu interface. SCI is at least for the control of NCR-Forwarding (NCR-Fwd) 255 within the NCR 250. NCR-MT 252 is not expected to have complete signal and channel awareness for signals and channels forwarded by the NCR-Fwd 255.

The NCR-Fwd 255 is defined as a function entity to perform the amplify-and-forwarding of one or more UL/DL RF signals between the base station 214 or gNB and WTRU 202 via backhaul link 220 and access link 260. In an example, WTRU 202 may be the same as or similar to one of the WTRUs 102a, 102b, 102c, 102d. The behavior of the NCR-Fwd 255 will be controlled according to the received side control information from the base station 214 or gNB. NCR-Fwd 255 is not expected to have any signal and channel awareness. In other words, NCR-Fwd 255, or NCR 250 may not know which and when signals and channels are forwarded.

The NCR 250 communicates and forwards the SCI and/or signals from base station 214 or gNB via Control-Link 210 and Backhaul Link 220, respectively, where one or more beam resources are used. In examples, the beam resources may be fixed beam resources or adaptive beam resources. As for the Access Link 260, there may be larger number of beams, such as, for example, N beams used to forward the signals from NCR 250 to the WTRUs, such as WTRU 202. The NCR 250 is configured regarding, or receives indications on, which beam at the Access-Link 260 to use to forward the signals.

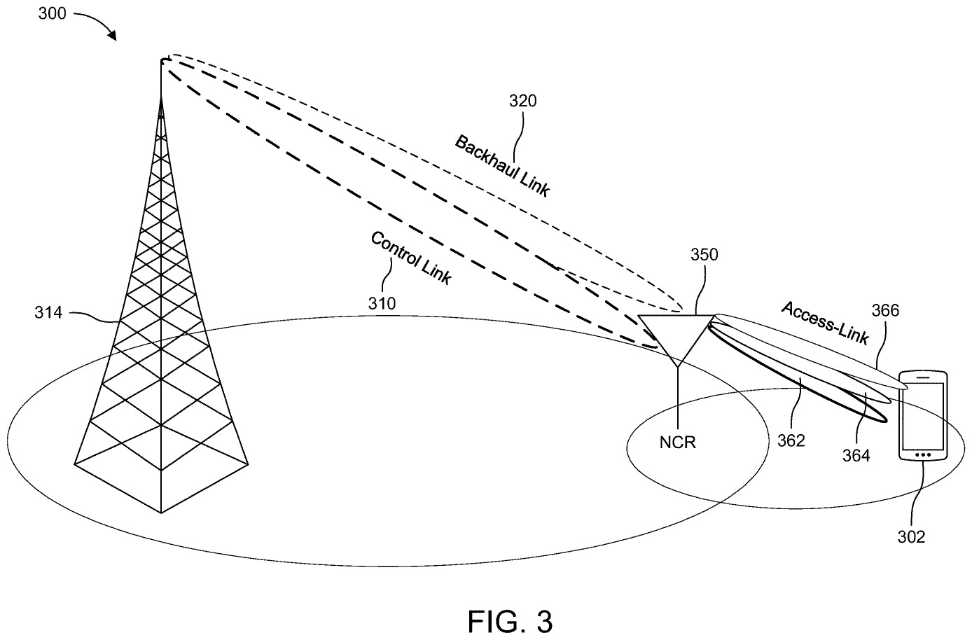

FIG. 3 is a system diagram illustrating an example of backhaul-link, control-link and access link beam resources As shown in an example in system diagram 300, the base station 314 or gNB may transmit all data for all WTRUs, such as WTRU 302, and all Access-Link beams, such as, for example, N access beams or access beams 362, 364, 366, via one or more beams at the Backhaul Link 320 to the NCR-FWD in NCR 350. In an example, base station 314 may be the same as or similar to base station 114a or 114b. In another example, WTRU 302 may be the same as or similar to one of the WTRUs 102a, 102b, 102c, 102d.

The base station 314 or gNB also may indicate to NCR-MT in NCR 350 which Access-Link beam, for example, out of the N beams, to be used and time to forward, transmit, and/or receive the signals. For example, the base station 314 may indicate to the NCR 350, using control information sent over control link 310, to use one or more of access link beams 362, 364, 366. In other words, the signals and/or information transmitted from base station 314 or gNB through Backhaul Link 320 to NCR 350, will be TDMed (multiplexed in time) and transmitted and/or received/and/or forwarded in Access-Link beams via the NCR 350. In an example, the Access-Link beams may be N Access-Link beams, such as access link beams 362, 364, 366.

In an example scenario, the NCR operation is transparent to WTRUs. However, NCR-MT has WTRU functionalities. For example, it is agreed that the TDD side control information for NCR will be based on semi-static and/or dynamic indications currently considered in NR specifications for the WTRU behavior. Moreover, some WTRUs in later releases can act like an NCR. For example, the concepts discussed in this disclosure can be generalized to frequency range 2 (FR2) side-link relays, that is the device-to-device communication as a way to extend the network coverage outside the area directly covered by the network infrastructure.

As used in embodiments and examples herein, an NCR may be a WTRU and a WTRU may be an NCR, and the terms NCR and WTRU may be used interchangeably.

In unmodified beam management, the beam indication is based on a channel state information reference signal (CSI-RS) resource indicator (CRI); whereas, for NCR, the Access Link's beams are indicated via beam indexes. Moreover, the beam indication in unmodified approaches is per channel, per UL, per DL, and so forth. However, NCR cannot have awareness of the forwarded channels and signals, in unmodified approaches.

The NCR may support semi-static and dynamic beam management for the Access Link. As such, the methods for indication of beam indexes and respective time-domain indications should be considered. For example, a consideration is how to efficiently indicate beam indexes and respective time resources for beam management in Access Link. Another consideration is what is the method for beam determination for an NCR by a base station or gNB based on SCI. A further consideration is how to use beam hierarchy, such as wide beams and narrow beams for beam indication enhancement.

Apparatus and methods in embodiments and example solutions herein of indicating multi-beams using beam patterns are provided. Association of beam indication and scheduled resources are discussed, where the details on beam pattern indication are investigated. Moreover, the beam Index and physical beams association in Access-Link along with methods on indexing the beams for Access-Link are provided in embodiments and example solutions herein.

As used in embodiments and examples herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example.’

A sign, symbol, or mark of forward slash ‘’ is to be interpreted as ‘and/or’ unless particularly mentioned otherwise, where for example, ‘A/B’may imply ‘A and/or B’.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a reference signal (RS), such as a CSI-RS, or a synchronization signal (SS) block. The WTRU transmission may be referred to as “target”, and the received RS or SS block may be referred to as “reference” or “source.” In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) signaling or signaled by a MAC control element (CE) or downlink control information (DCI). For example, a WTRU may implicitly transmit a physical uplink shared channel (PUSCH), or PUSCH transmission, and DM-RS of a PUSCH according to the same spatial domain filter as a sounding reference signal (SRS) indicated by an SRS resource indicator (SRI) indicated in DCI or configured by RRC signaling. In another example, a spatial relation may be configured by RRC signaling for an SRI or signaled by a MAC CE for a physical uplink control channel (PUCCH) transmission. Such a spatial relation may also be referred to as a “beam indication.”

The WTRU may receive a first, or target, downlink channel or signal according to the same spatial domain filter or spatial reception parameter as a second, or reference, downlink channel or signal. For example, such an association may exist between a physical channel such as a physical downlink control channel (PDCCH) or physical downlink shared channel (PDSCH) and its respective demodulation reference signal (DM-RS). At least when the first and second signals are reference signals, such an association may exist when the WTRU is configured with a quasi-colocation (QCL) assumption type D between corresponding antenna ports. Such an association may be configured as a transmission configuration indicator (TCI) state. A WTRU may be indicated with an association between a CSI-RS or SS block and a DM-RS by an index to a set of TCI states configured by RRC signaling and/or signaled by a MAC CE. Such an indication may also be referred to as a “beam indication.”

As used in embodiments and examples herein, a transmission and reception point (TRP) may be interchangeably used with one or more of transmission point (TP), reception point (RP), radio remote head (RRH), distributed antenna (DA), base station (BS), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with the embodiments and examples provided herein.

A WTRU may report a subset of channel state information (CSI) components, where CSI components may correspond to at least a CRI, an SSB resource indicator (SSBRI), an indication of a panel used for reception at the WTRU (such as a panel identity or group identity), measurements such as L1-RSRP, L1-SINR taken from synchronization signal block (SSB) or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

Herein, a signal may be interchangeably used with one or more of following: an SRS, CSI-RS, DM-RS, Phase tracking reference signal (PT-RS), and SSB, and still be consistent with embodiments and examples provided.

Herein, a channel may be interchangeably used with one or more of following: a PDCCH, PDSCH, PUCCH, PUSCH, Physical random access channel (PRACH), and the like, and still be consistent with embodiments and examples provided.

Herein, a RS may be interchangeably used with one or more of an RS resource, RS resource set, RS port and RS port group, but still consistent with embodiments and examples provided.

Herein, RS may be interchangeably used with one or more of an SSB, CSI-RS, SRS, and DM-RS, but still consistent with embodiments and examples provided.

Herein, an NCR may be a WTRU and a WTRU may be an NCR, and NCR and WTRU may be used interchangeably, but still consistent with embodiments and examples provided.

Herein, the terms “access beam” and “access-link beam” may be used interchangeably, but still consistent with embodiments and examples provided.

Herein, the terms beam pattern, beam pattern type, beam pattern mode, beam pattern set, beam arrangements, sequence of beams, states, and states index may be used interchangeably, but still consistent with embodiments and examples provided.

Herein, the terms control channel, control signaling, control information, PDCCH, DCI, and side control information may be used interchangeably, but still consistent with embodiments and examples provided.

Herein, the terms configured, indicated, received, and determined may be used interchangeably, but still consistent with embodiments and examples provided.

Herein, the terms configuration and indication may be used interchangeably, but still consistent with embodiments and examples provided.

Herein, the terms forwarding, relaying, transmission, and reception may be used interchangeably, but still consistent with embodiments and examples provided.

Herein, the terms beam, beam pattern, beam index, and any other reference to the beam resources may be interpreted as Access-Link beam, Access-Link beam pattern, Access-Link beam index, and so forth, respectively, unless particularly mentioned otherwise.

In embodiments herein, beam patterns for multi-beam indication are provided. Also provided are an association of beam indication and scheduled resources. Further provided are beam index and physical beams association in an access-link. For example, indexing the beams for access-link is provided.

In embodiments and examples provided herein, the indication of multiple beams in one indication may be based on beam patterns and hierarchical beams. In an example, an NCR may be configured (e.g., via RRC, MAC-CE, DCI) with the beam indexes to be used for access link.

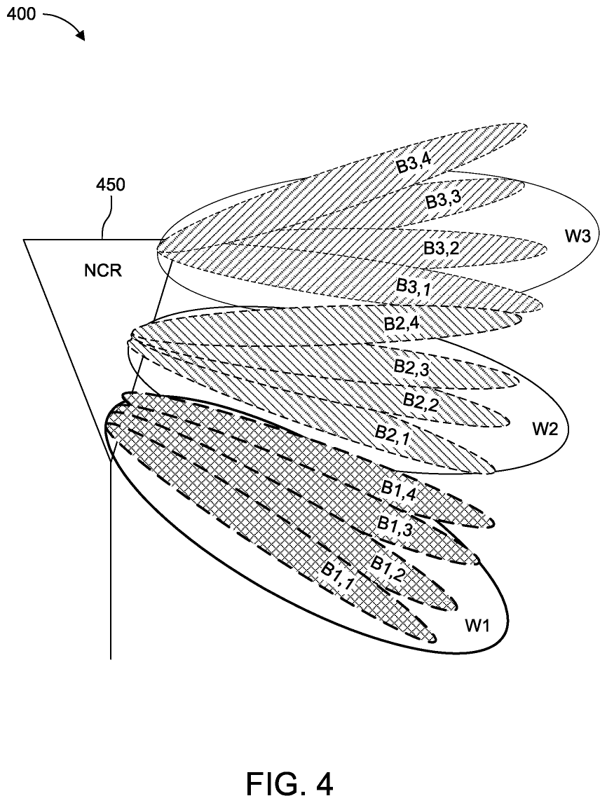

FIG. 4 is a beam pattern diagram illustrating an example of hierarchical beams in an access link. As shown in an example in beam pattern diagram 400, beams may be independently indexed per beam types. For example, a beam index may be or may include: {W1; W2; B1,1; B1,2; B1,3; B2,2; B2,3; B2,4}. NCR 450 may use several beam patterns. For example, NCR 450 may use beam W1 for a wide beam and beams B1,1, B1,2, B1,3, B1,4 for narrow beams. Further, NCR 450 may use beam W2 for a wide beam and beams B2,1, B2,2, B2,3, B2,4 for narrow beams, in an example. In another example, NCR 450 may use beam W3 for a wide beam and beams B3,1; B3,2; B3,3, B3,4 for narrow beams.

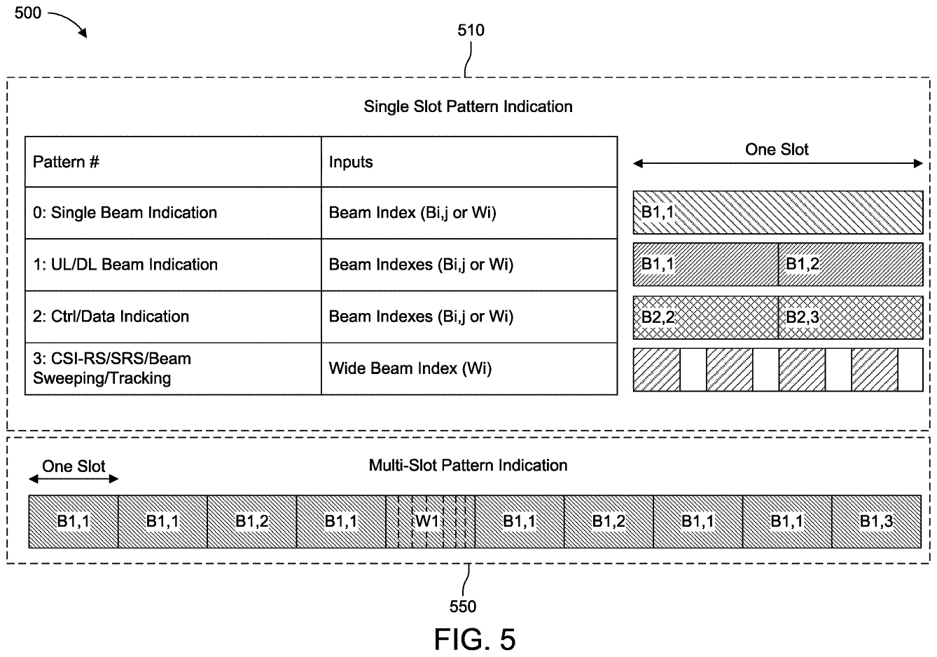

FIG. 5. is a beam pattern indication diagram illustrating an example of single-slot or multi-slot beam pattern indication. In an example shown in beam pattern indication diagram 5, the NCR may be configured with a set of beam pattern parameters for Access-Link transmission, where the beam patterns indicate the beam allocations on one or more time resources. The NCR may be configured via RRC, MAC-CE, DCI or the like, in examples. In an example, in Pattern#0, the NCR is using B1,1 for the whole time/freq. resources. In another example, in Pattern#1 and #2, the NCR is using two beams within the time/freq. resources. In a further example, in multi-slot pattern, the NCR is configured with the beams to be used in different time resources.

The NCR receives beam pattern index implying one of the entries from the set of beam pattern parameters, in an example. The NCR receives the starting time, beam type (wide or narrow beam), beam indexes, periodicity (if required), and the like regarding the configured beam pattern. The time granularity regarding the beam pattern is indicated. In example, the time granularity may include one or more of symbol, slot, subframe, and the like. The time duration for which the beam pattern is going to be applied is indicated, and may include one or more of, for example, symbols, slot, frame, and periodicity. Beam transmission direction (UL or DL) can be indicated via a bitmap, for example, 0: UL, 1: DL. In an example, for Pattern #1 the bitmap implies that the first beam is for UL and the second beam is for DL. Beam Type can be indicated via a bitmap, for example, 0: Wide beam, 1: Narrow beam. In an example, for Pattern #2 the bitmap {1,1} implies that both beams are narrow beams.

The beam indication could be different based on beam pattern and the hierarchical beams. As such, instead of indicating multiple narrow beams, only the associated wide beam could be indicated. For example, in Pattern #1, instead of indicating {B1,1; B1,2}, only W1 is indicated. For example, in Pattern #3 for beam sweeping, instead of indicating {B1,1; B1,2; B1,3; B1,4}, only W1 is indicated. For example, in multi-slot pattern indication, instead of indicating {B1,1; B1,2; B1,3}, only W1 is indicated.

Based on the received beam patterns, the NCR determines one or more time-domain resources and the beam indexes corresponding to each resource.

The NCR uses the determined beam resources for UL/DL forwarding of the data at the configured time resources.

An example includes reporting Access Link's physical beam characteristics and beam selection. An NCR may report the number of the beams for access link along with each beam's physical beam characteristics, such as beam directions, for example, a boresight angle.

Additionally or alternatively, the NCR may report the physical characteristics only for a set of reference beams and then indicate the other beams accordingly, for example, indicating the neighbor beams, indicating via right/left/up/down. The NCR may use a single-or two-dimensional array of beams, in an example.

Additionally or alternatively, the gNB or base station may perform beam sweeping over all beams in the Access-Link. The base station or gNB determines one or more CSI-RS resource sets, for example, for different beam types. The base station or gNB indicates the beam pattern, for example, time resources, to the NCR for beam sweeping. The NCR uses the time pattern to switch the beams at the Access-Link, one at a time. The base station or gNB receives respective CSI reports, determines, and indicates the beams to be used by the NCR at the Access-Link.

Additionally or alternatively, the NCR may determine a set of beams, for example, based on direction, diversity, correlation, and suggests them to a base station or gNB. The base station or gNB transmits one or more reference signals based on the suggested beams, that is forwarded via the NCR. The base station or gNB receives respective CSI reports and determines if the selected beams have acceptable performance. For example, an acceptable performance may be if, reference signal received power (RSRP) and/or CQI are above (>) a threshold, and/or Hypothetical block error rate (BLER) is below (<) a threshold.

If the base station or gNB finds a problem with a beam in the Access-Link, the base station or gNB asks the NCR to change it dynamically. In an example, a problem may be if the Access-Link is not in the optimal direction based on CQI, Hypothetical BLER, or rate of beam failure recovery (BFR) requests received from served WTRUs.

In an example, the base station may send indication information to the NCR requesting that the NCR undertake a dynamic beam change overriding a previous selected Access Link. The indication information may include: the beam that is being overridden and the beam that is going to override, when to start the override, and how long to override. For example, the override may last until another indication.

Further, the overriding beam may take affect only in specific resources/patterns. For example, the indication information may include whether the overriding beam is going to take effect in both UL and DL, or only in UL, or only in DL.

The NCR should consider the change for the semi-static beam configurations that were previously configured. The indication information may include the substitute narrow beam index, for example, narrow beam, or the parent wide beam.

Further, if the substitute narrow beam index is not indicated by the base station, the NCR may determine the overriding second beam. In examples, the NCR may determine the overriding second beam based on physical beams, or based on a relative indication from the base station. The relative indication may indicate the beam on the left/right/up/down of the first beam, in examples.

In embodiments and examples provided herein, a null beam indication in SCI may be based on scheduled resources. An NCR receives a beam pattern and respective configurations including beam indexes. The NCR determines that a NULL beam index is configured for one or more of the time resources in the beam pattern. The NULL beam index could be a specific and/or (pre)configured beam index. Upon detection of a NULL beam index, the NCR determines that no data forwarding and/or transmission is scheduled for respective time resources. For example, the NULL beam index can implicitly indicate the OFF status for the forwarding and/or reception and/or transmission.

In embodiments and examples provided herein, other details on beam pattern indications may be provided. For example, the base station may provide SCI type for beam pattern indication, which may include: semi-static indication information and/or dynamic indication information. A semi-static indication information could be for periodic symbols, such as periodic reference signals. The dynamic indication information may be for dedicated signaling. Further, semi-static indication information may be cell specific, for fixed locations, and like. Also, if a beam direction is going to change, the dynamic indication information could override the semi-static configuration indication information.

Also, the base station may provide beam patterns indication information based on signals and/or channels configurations. In an example, the beam indication patterns may be different based on signals and/or channel configurations, for example, UL/DL, On/OFF, NCR-MT/NCR-FWD, Control/Data.

An example of indication information includes reporting NCR capability including beam application times. For example, the indication information may include reporting beam application time for different SCI length or content. In an example, the reporting beam application time may include SCI decoding time.

The NCR may report one or more beam application times based on different beam pattern indications, such as, for example, single-slot beam patterns or multi-slot beam patterns. The NCR may report maximum beam application time. The base station or gNB may consider the reported beam application time in sending the beam pattern indications long before the scheduled transmission, reception, and/or forwarding.

Further examples may include associating Access Link beam indexes and physical beams. Beams may be independently indexed per beam types: Separate beam indexes may be used for beams of a same type, but beam indexes can be shared for different beam types. In an example, the wide beams up to a maximum number of wide beams are indexed. Then, the narrow beams are indexed: for example, {W1; W2; W3; res; res; B1,1; B1,2; B1,3; B1,4; B2;1; B2,2; B2,3; B2,4, B3,1; B3,2; B3,3; B3,4})}. Beams are hierarchically indexed for different beam types, in an example. For example, each wide beam is followed by its associated narrow beams in indexing: for example, {W1; B1,1; B1,2; B1,3; B1,4; W2; B2;1; B2,2; B2,3; B2,4; W3; B3,1; B3,2; B3,3; B3,4})}.

Embodiments and examples are provided herein for beam patterns for multi-beam indication. An NCR may be configured, for example, via RRC signaling, a MAC-CE, DCI, or the like. with one or more beam indexes to be used for NCR-FWD at the Access-Link. For example, the beams may be independently indexed per beam types, for example, {W1; W2; B1,1; B1,2; B1,3; B2,2; B2,3; B2,4}). Examples related to this approach are provided in FIG. 4 and additional examples are provided further below.

In an example solution, one or more beam patterns at the Access-Link may be used, defined, configured, or determined and each of the beam patterns may be a subset of a beam pattern set. FIG. 5 shows some examples of beam patterns. A beam pattern set may be mutually exclusive to another beam pattern set. An NCR may determine one or more symbols, slots, time units, and/or time resources for which to use one or more determined, configured and/or indicated beam patterns and respective access beam indexes. For example, the NCR may use one or more of the configured and/or indicated access beam indexes for the transmission, reception, and/or forwarding of signals and channels in one or more configured and/or indicated time resources, based on one or more of the determined, configured, and/or indicated beam patterns.

The beam pattern configuration may be based one or more of the following. The beam pattern may be based on a single-slot configuration 510. In an example solution, a beam pattern set may be used, defined, configured, or determined for single-slot configuration. As such, each beam pattern may be used, defined, configured, or determined to indicate the configuration of symbols within a slot and respective beam allocations, for example, access beam indexes. For example, in FIG. 5, Pattern #0 is provided as an example for single beam indication, where the NCR may use access beam index B1,1 for the whole time and frequency resources. In a further example, in FIG. 5, Pattern #1 and Pattern #2 are provided as two examples, where the NCR may use two access beams within the time and frequency resources.

For example, Pattern #1 may use beams B1,1 and B1,2. In another example, Pattern #2 may use beams B2,2 and B2,3.

The beam pattern may be based on a multi-slot configuration 550. In an example solution, a beam pattern set may be used, defined, configured, or determined for more than one slot configuration. In an example, each beam pattern may be used, defined, configured, or determined to indicate the configuration of symbols within the slots and respective beam allocations, for example, access beam indexes. In another example, each beam pattern may be used, defined, configured, or determined to indicate the configuration of the slots and respective beam allocations, for example, access beam indexes, based on one or more single-slot configurations. For example, in FIG. 5, a multi-slot beam pattern 550 is provided as an example, where the NCR may be configured with the beams to be used in different time resources.

A beam pattern may indicate an arrangement for a first access beam index including the number of symbols, slots, and/or time units, as well as the duration and/or the starting offset to define where the first access beam index may be used. The beam pattern may also indicate the arrangements for a second, third, and up to, for example, a configured maximum number of access beam indexes, for example, N. The number of arrangements indicated in a beam pattern (e.g., N) in may be determined based on NCR capability, duplex mode (e.g., TDD or FDD), transmission direction (UL/DL), ON/OFF status, and so forth. Related examples are provided further below herein.

In an example solution, one or more beam pattern sets may be used, and each beam pattern set may be associated with a mode of operation. For example, if an NCR is indicated or configured to use a beam pattern from a first beam pattern set, the NCR may perform a first mode of operation associated with the first beam pattern set; if the NCR is indicated or configured to use a beam pattern from a second beam pattern set, the NCR may perform a second mode of operation associated with the second beam pattern set, and so forth. The mode of operation may include at least one of following.

For example, the mode of operation may include an ON/OFF configuration. For example, one or more beam patterns may include indications on the access beam indexes only for one or more time windows within the beam pattern time duration. As such, the NCR may determine that the NCR-FWD is in the OFF status within the remaining time windows. In an example, the remaining time windows may be the time windows with no beam indication. Related examples are provided further below herein.

In another example, the mode of operation may include a UL/DL configuration. For example, one or more beam patterns may include indications on one or more access beam indexes, where some of the access beam indexes are for the uplink and the remaining are for the downlink. As such, the NCR may determine that the NCR-FWD is in the UL status for the access beam indexes that belong to the set of UL access beam indexes, and that the NCR-FWD is in the DL status for the access beam indexes that belong to the set of DL access beam indexes.

In a further example, the mode of operation may include a timing configuration. For example, one or more beam patterns may include indications on one or more access beam indexes, for which one or more timing arrangements are used, indicated, configured, and/or determined. In an example, a first access beam index may be indicated and/or configured to be used with a first configured and/or indicated time delay or timing advance; also, a second access beam index may be indicated and/or configured to be used with a second configured and/or indicated time delay or timing advance, and so forth. As such, the NCR may determine to apply the configured and/or indicated timing arrangement for the respective access beam indexes.

In an additional example, the mode of operation may include a power control configuration. For example, one or more beam patterns may include indications on one or more access beam indexes, for which one or more transmission and/or reception power control configurations are used, indicated, configured, and/or determined. In an example, a first access beam index may be indicated and/or configured to be used with a first transmission and/or reception power configuration; whereas a second access beam index may be indicated and/or configured to be used with a second transmission and/or reception power configuration, and so forth. As such, the NCR may determine to apply the configured and/or indicated transmission and/or reception power configurations for the respective access beam indexes.

In an example solution, an NCR receives one or more beam pattern indexes, where a beam pattern index indicates one of the entries from the set of beam pattern parameters. In examples, the one or more beam pattern indexes may be received via a SIB, RRC signaling, a MAC-CE, DCI or the like. One or more of the following may apply.

In examples, an NCR may receive an implicit indication of a beam pattern index. The implicit indication may be based on side control information. For example, one or more received side control information message may be used as one or more implicit indications of one or more beam patterns. In an example, the ON/OFF side control information indication may imply one or more beam patterns from one or more beam pattern sets. In another example, UL/DL side control information indication may imply one or more beam patterns from one or more beam pattern sets.

In further examples, an NCR may receive an explicit indication of a beam pattern index. The explicit indication may be a System Information Block (SIB) indication. For example, the NCR may receive the one or more indications based on decoding one or more SIBs. Based on the decoded SIBs, the NCR may identify which beam pattern to be used.

In another example, the explicit indication may be a semi-static indication. For example, the NCR may receive the one or more indications based on one or more semi-static configurations, such as, for example, via RRC signaling. Based on the one or more semi-static configurations, the NCR may identify to use one or more beam patterns and/or beam pattern sets.

In a further example, the explicit indication may be a dynamic indication. For example, the NCR may receive the one or more indications based on decoding one or more dynamic configurations, such as, for example, via an MAC CE and/or DCI. Based on the decoded dynamic indication, the NCR may identify which beam pattern to be used. For the dynamic indication, the NCR may receive activations (e.g., via MAC CE) of semi-statically configured modes (e.g., via RRC). Based on the activations, the NCR may receive the one or more indications (e.g., via DCI) of the activated beam patterns.

In an example solution, upon reception, indication, configuration, and/or determination of a beam pattern, an NCR may receive, determine, or be configured with one or more of the following parameters. In an example, the NCR may receive, determine, or be configured with Access-link Beam indexes. For example, the NCR may receive one or more access beam indexes corresponding to the beam pattern to be applied and/or used in the pattern, sequence, and/or order indicated in the beam pattern. In another example, an NCR may receive a first access beam index, wherein the NCR may use one or more access beam indexes that are associated with the first access beam index.

In another example, the NCR may receive, determine, or be configured with a starting time. For example, the NCR may receive the starting time for which the beam pattern may be used and/or applied. The starting time may be indicated based on the number of symbols, slots, subframes, frames, time units, and so forth.

In a further example, the NCR may receive, determine, or be configured with a time duration. For example, the NCR may receive the time duration for which the beam pattern may be used and/or applied. The time duration may be indicated based on the number of symbols, slots, subframes, frames, time units, and so forth.

In an addition example, the NCR may receive, determine, or be configured with a periodicity. For example, the NCR may receive the time period for which the beam pattern may be used and/or applied. The periodicity timing may be indicated based on the number of symbols, slots, subframes, frames, time units, and so forth.

In yet another example, the NCR may receive, determine, or be configured with a time granularity. For example, the NCR may receive the configuration on the granularity of the time units, for example, starting time, duration, and so forth. The granularity may be indicated based on the number of symbols, slots, subframe, time units, and so forth. As such, the NCR may use the configured time granularity to use and/or apply the configured beam pattern accordingly.

In yet a further example, the NCR may receive, determine, or be configured with an access-link Beam type. For example, the NCR may receive the configuration on the beam type for the configured beam pattern. The beam type may be indicated based on beam width (e.g., wide or narrow), frequency range (e.g., FR1, FR2-1, FR2-2), and so forth. As such, the NCR may use the access beam indexes corresponding to the configured beam type in order to use and/or apply the configured beam pattern accordingly. For instance, the access beam type may be indicated via a bitmap (e.g., 0: Wide beam, 1: Narrow beam).

In yet an addition example, the NCR may receive, determine, or be configured with a UL/DL forwarding direction. For example, the NCR may receive the configuration on the uplink or downlink direction for the configured beam pattern. As such, the NCR may use the access beam indexes corresponding to the UL reception, if the forwarding direction is configured to be UL; the NCR may use the access beam indexes corresponding to the DL reception, if the forwarding direction is configured to be DL. In an example, the access beam forwarding direction (e.g., UL or DL) may be indicated via a bitmap (e.g., 0: UL, 1: DL).

In an example solution, an NCR may receive one or more beam indications based on the one or more configurations. For example, if the NCR receives a first set of configurations, the NCR may receive the one or more beam indications based on the first type of beam indications. If the NCR receives a second set of configurations, the NCR may receive the one or more beam indications based on the second type of beam indications.

The one or more configurations may be one or more of the following. The one or more configurations may be an indicated beam pattern. For example, the NCR may determine a first type of beam indications for a first beam pattern and a second type of beam indications for a second beam pattern.

In another example, the one or more configurations may be or may include a slot format. For example, the NCR may determine a first type of beam indications for a first slot format and a second type of beam indications for a second slot format.

In a further example, the one or more configurations may be or may include a Start and Length Indicator Value (SLIV). For example, the NCR may determine a first type of beam indications for a first SLIV and a second type of beam indications for a second SLIV.

In an additional example, the one or more configurations may be or may include a channel type. For example, the NCR may determine a first type of channel (e.g., PDSCH/PUSCH mapping type A) for a first slot format and a second type of channel (e.g., PDSCH/PUSCH mapping type B) for a second slot format.

In an example solution, an NCR may receive one or more beam indications with different information, different payload size or both for each type of beam indication. In an example, the payload size may be a number of bits.

The different information may be or may include one or more of the following. In an example, the different information may be or may include an indication of beam type. For example, the NCR may receive an indication of only one or more wide beam indexes for a first type of beam indication. For example, the NCR may receive an indication of one or more wide beam indexes and one or more narrow beam indexes for a second type of beam indication. In an example, the one or more narrow beam indexes may be associated with the one or more wide beam indexes. For example, the NCR may receive an indication of only one or more narrow beam indexes for a third type of beam indication.

In another example, the different information may be or may include a number of beams. For example, the number of one or more wide beam indexes and/or number of one or more narrow beam indexes may be determined.

In an additional example, the different information may be or may include a mapping of indicated beams. For example, mapping of indicated beam indexes to time and/or frequency resources may be determined based on a first type of beam indication.

For example, an NCR may determine a first type of beam indication for Pattern #0. For the first type of beam indication, the NCR may receive one narrow beam and map the narrow beam for a time and frequency resource.

In a further example, an NCR may determine a second type of beam indication for Pattern #1/#2. For the second type of beam indication, the NCR may receive one or more narrow beams and map one of the one or more narrow beams for each time and frequency resource. In another example, instead of indicating the one or more narrow beams, the NCR may receive one wide beam index and map one or more narrow beams associated with the indicated wide beam for the time and frequency resources.

In another example, an NCR may determine a third type of beam indication for Pattern #3. For the third type of beam indication, the NCR may receive one or more narrow beams and map one of the one or more narrow beams for each time and frequency resource. In another example, instead of indicating the one or more narrow beams, the NCR may receive one wide beam index and map one or more narrow beams associated with the indicated wide beam for the time and frequency resources.

In an additional example, in multi-slot pattern indication, instead of indicating narrow beam indexes, only one wide beam index may be indicated, and an NCR may map applicable associated narrow beams based on the indicated wide beam index. The association between wide beam index and narrow beam indexes may be indicated based on one or more of RRC signaling, a MAC CE and DCI.

In another example, the different information may be or may include a payload size, such as, for example, a number of bits for one or more beam indications. For example, a payload size of one or more beam indication may be dynamically determined based on a determined beam indication type. For example, a payload size of one or more beam indication may be semi-statically determined based on a maximum payload size of applicable beam indication types based on the one or more of the following configurations: Indicated beam pattern; Slot format; SLIV; or Channel type.

Embodiments and examples are provided herein of an association of beam indication and scheduled resources. A null beam may be defined, used, configured, or determined, wherein the null beam may be referred to as at least one of following.

A null beam may be referred to as a beam or beam index which may indicate no signal transmission toward any spatial direction in a certain time/frequency resource, for example, effective isotropic radiated power (EIRP) is almost zero, or zero, in all spatial direction in a certain time/frequency resource. The certain time resource may be at least one of but not limited to a time unit (e.g., slot, ms), a set of time units, a set of consecutive time units, wherein the time unit may be OFDM symbol, slot, physical slot, logical slot, radio frame, subframe, sidelink slot, system frame number (SFN), and so on. The certain frequency resource may be bandwidth part, subband, resource block (RB), set of RBs, carrier, a set of carriers, operating bandwidth, and system bandwidth.

Also, a null beam may be referred to as a beam or beam index which may indicate no signal transmission toward the beam direction indicated in a certain time/frequency resource, for example, EIRP is almost zero, or zero, in the beam direction in a certain time/frequency resource. A beam or beam index which may indicate OFF status of the transmitter (or receiver) which may perform uplink transmission, access link transmission, or a sidelink transmission based on the indicated beam information, wherein the transmitter (or receiver) may be at least one of gNB, TRP, repeater, relay node, WTRU, integrated access and backhaul (IAB) node, and so forth.

Further, a null beam may be referred to as a beam or beam index which may indicate starting of a certain state, wherein the certain state may include at least one of: a state of discontinuous reception (DRX), or connected mode DRX (C-DRX) which may include OFF-duration, ON-duration, etc. ; a state of RRC configuration which may include RRC connected, RRC idle, RRC inactive; or a state of sleep which may include go-to-sleep, wake-up.

Additionally, a null beam may be referred to as a beam or beam index which may indicate a certain state for a certain time duration. Moreover, a null beam may be referred to as a beam or beam index which may indicate stop performing current activity, wherein the current activity may include relaying a signal, repeating a signal, decode-and-forward a signal, amplify-and-forward a signal, and so forth.

In embodiments and examples herein, a WTRU may be interchangeably used with transmitter, receiver, IAB node, gNB, TRP, repeater, relay, relay WTRU, repeater WTRU, and device. Also, in embodiments and examples Herein, a signal may be interchangeably used with physical channel, data, PDCCH, PDSCH, reference signal, OFDM signal, OFDM symbol, modulated data, and waveform. When a WTRU is indicated with a null beam for a transmission of a signal, the WTRU may perform null beam transmission mentioned above.

In an example solution, a WTRU may be indicated a sequence of beams via a control information associated with a sequence of signals to be transmitted, the WTRU may transmit the sequence of signals with the associated beams indicated, wherein the sequence of beams may include one or more null beams. One or more of following may apply.

The control information may be at least one of: dynamic signaling, or semi-static signaling. In an example, the dynamic signaling may include one or more of Side control information, dynamic control information, sidelink control information, a sequence or the like. In another example, the semi-static signaling may include one or more of RRC signaling, a MAC-CE or the like.

The sequence of beams may be a sequence of beam indices, for example, a set of TCI states. Additionally or alternatively, the sequence of beams may be a set of beams, (or beam indices, which may be associated with a set of time resources. For example, the set of time resources may be or may include a set of slots.

The sequence of signals may be a set of signals received from a transmitter, wherein the signal may be received in the same frequency band or a different frequency band from the control information carrying information about the sequence of beams. In an example, the transmitter may be a base station, gNB, TRP, roadside unit (RSU), location management function (LMF) or the like. A WTRU may receive the information about the sequence of beams first. In an example, the WTRU may receive the information a time T earlier than receiving the first signal of the sequence of signals associated with the sequence of beams. Then the WTRU may transmit a signal, for example, receive and forward a signal, with the indicated beam index when the signal is received. The time T may be a WTRU capability reported to base station or gNB or configured by a base station or gNB.

The sequence of signals may be generated at the WTRU, for example, from a WTRU buffer. The sequence of beams may be configured via a higher layer signaling and a WTRU may determine a beam for a signal transmission with the configured beam. Each beam index, for example, of the sequence of beams) may be associated with a time resource or a time unit, for example, a slot or a set of slots. If a single beam index is provided or configured, the same beam may be applied for all signals transmitted from the WTRU.

In another example solution, a WTRU may be indicated a null beam implicitly. For example, a WTRU may transmit a null beam for the one or more associated time resources when one or more of following conditions are met.

The WTRU may transmit a null beam if the WTRU did not receive control information associated with one or more time resource, or time units. In an example, the control information may be SCI.

Also, the WTRU may transmit a null beam if a measurement of certain time/frequency resource is higher than a threshold, wherein the measurement may be at least one of RSRP, reference signal received quality (RSRQ), received signal strength indicator (RSSI), L1-RSRP, L1-RSRQ, L1-SINR, CQI, and so forth. The certain time/frequency resource may be configured and associated with one or more time resources.

Further, the WTRU may transmit a null beam if a channel quality is below a threshold, wherein the channel quality may be determined based on measurement. In another example, the WTRU may transmit a null beam if a resource pool quality is below a threshold, wherein the resource pool quality may be determined based on measurement In another example solution, an NCR may be indicated, configured, and/or provided (e.g., semi-statically via a SIB1, RRC signaling, and so forth) with one or more beam indexes that can be considered as “flexible and/or unknown beam indexes”. As such, the NCR may determine that one or more of the flexible and/or unknown beam indexes are indicated and/or configured (e.g., as part of one or more beam patterns) for one or more time resources. The NCR may determine to consider the OFF status during respective configured and/or indicated time resources, unless a dynamic indication is received for the respective time resources. As such, the NCR may receive a dynamic indication (e.g., via DCI and/or a MAC-CE) to indicate and/or configure one or more access beam indexes for the time resources that were configured with “flexible beam indexes.” Examples provided herein include an SCI type for beam patter indication. The SCI type may be semi-static and/or dynamic.

In an example solution, a beam pattern for NCR may be semi-statically indicated/configured by the base station or gNB. For example, an NCR may be semi-statically indicated, semi-statically configured, or both, to use a beam pattern, for example, via RRC signaling. As such, unless the NCR receives any further beam pattern indication, the NCR may use the semi-statically indicated beam pattern.

A semi-statically indicated beam pattern may only configure symbols used for the transmission/reception of specific symbols in a slot or group of slots. For example, symbols used for one or more periodic reference signals and/or one or more periodic system information transmissions may be configured by a semi-statically indicated beam pattern. In an example, the periodic reference signals may be periodic CSI-RSs, SRSs, tracking reference signals (TRSs) or the like. Also, the periodic system information transmissions may be periodic SIB1s.

The NCR may assume that the time units that are not configured via semi-static beam pattern configuration and/or indication, may be OFF and/or muted. In an example, the time units may be symbols, slots, frames, or the like. In an example, the NCR may be configured with a semi-static beam pattern, where a first access beam may be configured to be used for a first set of symbols in a slot (e.g., symbols 1 and 2); a second access beam may be configured to be used for a second set of symbols in a slot (e.g., starting from symbol 5 to the end of the slot). As such, the NCR may determine that the symbols not configured with a beam pattern may be OFF, muted, or both, for example, no transmission, reception, and/or forwarding is scheduled.

In an example solution, an NCR may receive beam pattern indication via dynamic signaling. For example, an NCR may receive one or more indications and/or configurations for one or more access beam patterns, for example, via RRC signaling. The NCR may further receive one or more indications, for example, from the base station or gNB to dynamically activate or deactivate one or more specific access beam patterns out of RRC configured set of beam patterns, for example, via a MAC-CE indication, a DCI indication, or both.

In an alternative or an additional example, an NCR may receive configuration information for one or more access beam patterns, for example, via RRC signaling. Out of RRC configured beam patterns, a subset of access beam patterns may be activated or deactivated, for example, via a MAC-CE or DCI. In an example, the DCI may be group DCI which is received by more than one NCR. Additionally or alternatively, the DCI may be NCR specific DCI, in other words, a DCI decoded only by a specific NCR.

In an example solution, a semi-static beam pattern indication may be configured for one or more groups of NCRs. For example, an NCR may receive cell-specific beam pattern configuration information. In an example, cell-specific beam pattern configuration may be received via RRC signaling or broadcast signaling, for example, a system information transmission.

In addition to receiving the semi-static beam pattern indication information associated for the group of NCRs, an NCR in the group may also receive NCR specific beam pattern indication information dynamically. For example, an NCR that has previously received cell-specific beam pattern indication information, for example, via RRC signaling, may receive NCR specific beam pattern indication information, for example, via a MAC-CE, DCI, or both.

In an example solution, an NCR may override one or more semi-statically configured and/or indicated beam patterns for one or more time units in a slot and/or one or more slots in a group of slots (if the beam patterns are configured for a group of slots with each beam in the pattern associated with a slot) by a dynamically indicated beam pattern.

In an additional or alternative example solution, the NCR may override one or more semi-statically configured and/or indicated beam patterns for one or more time units in a slot and/or one or more slots in a group of slots except for specific time units (e.g., symbols/slots) configured by the base station or gNB and/or used for a specific signal transmission (e.g., an SSB transmission) by a dynamically indicated beam pattern.

In an additional or alternative example solution, the NCR may override one or more semi-statically configured and/or indicated beam patterns for one or more time units in a slot and/or one or more slots in a group of slots by a dynamically indicated beam pattern based on the change of the UL/DL direction. For example, if the UL/DL direction changes for a time unit (e.g., symbol) configured with an access beam based on cell-specific semi-static beam pattern configuration information, indication information, or both, the NCR may determine the beam associated for the respective time unit based on a dynamically indicated beam pattern. If the UL/DL direction does not change, the NCR may determine to use the beam configured for the respective time unit based on semi-static beam pattern configuration information, indication information or both.

In an example solution, an NCR may determine an access beam pattern based on signals and/or channel configuration information, for example, UL/DL, ON/OFF, Control/Data, or the like. To this end, the NCR may determine the beam pattern based on one or more of the following examples.

For example, the NCR may be configured with one or more beam patterns. Based on the UL/DL configuration, the NCR may determine the beam pattern to be used for one or more time units, for example, a specific slot or group of slots. For example, the NCR may be configured with a first and a second access beam patterns. As such, the NCR may use the first pattern if a slot is configured for UL, for example, for forwarding from WTRU to base station or gNB. The NCR may use the second pattern if the slot is configured for DL, for example, for forwarding from base station or gNB to WTRU.

For example, the NCR may be configured with one or more beam patterns. The NCR may receive configuration information to activate specific beam pattern based on the number of ON/OFF symbols in a time unit, for example, a slot, slot group, subframe, and so forth. In an example, the NCR may receive the configuration information via one or any combination of RRC signaling, a MAC-CE indication, or a DCI indication. Based on the number of ON/OFF time units, for example, in a slot or the a slot group, the NCR may determine one or more beam patterns to be activated for the respective time unit, for example, a slot, a group of slots, or both.

For example, the NCR may be configured with one or more beam patterns. The NCR may receive configuration information to activate specific beam pattern out of the configured beam patterns based on the type of signals to be transmitted, for example, control signals or data signals. For example, the NCR may be configured with a first and a second beam patterns. The NCR may activate the first pattern if one or more control signals is configured to be forwarded in a time unit. In an example, the control signals may be PDCCH signals. In another example, the control signals may be PUCCH signals. Otherwise, the NCR may activate the second pattern.

In an example solution, an NCR may indicate, report, or both, for example, to a base station or gNB, the capabilities associated with a beam, beam pattern application time, or both. In an example, beam pattern application time may be or may include the time that the NCR takes from the instance that the SCI carrying beam pattern indication is received to the instance of activation using the indicated beam pattern.

In an additional or an alternative solution, the NCR may report a different beam, a different beam pattern application time, or both based on one or more of the following configurations. The NCR may report based on the size of the SCI, in an example.

Further, the NCR may report based on the signaling type of SCI indicating a new beam, a new beam pattern indication, or both. In an example, the SCI indication information may include a, first beam, a beam pattern application time, or both for layer 1, for example, DCI, based SCI carrying the new beam pattern indication, and the second beam, second beam pattern application time, or both, for layer 2, for example, a MAC-CE, based SCI carrying the new beam, the new beam pattern indication, or both.

Also, the NCR may report based on the time duration of the beam pattern. In an example, the time duration of the beam patterns may be or may include single-slot beam patterns or multi-slot beam patterns.

Moreover, the NCR may report based on the type of beams in the current beam pattern and the new beam pattern. For example, the current beam pattern may consist of all narrow beams and the new pattern may consist of all wider beams.

In another additional or alternative example solution, the NCR may report the maximum beam application time to the base station or gNB. The NCR may report beam application time in terms of one more time units, for example, symbols, slots, absolute time (in ms for example), and so forth.

In an example solution, an NCR may activate a new beam pattern indicated immediately after the expiry of beam application time. In an additional or alternative example solution, the NCR may apply the new beam pattern after the time unit, for example, the slot, the multiple slots, or both, that the current beam pattern in use is configured for.

The NCR may determine, may expect, or both, that the base station or gNB considers the reported beam, the beam pattern application time, or both, in sending the beam pattern indications with sufficient time in advance to one or more of the scheduled transmission, the scheduled reception, or the scheduled forwarding.

In some example solutions, the NCR receives indication of an access beam applicable to a symbol or slot by first determining an association between an access beam and an access beam state index for at least one access beam state index, and by second receiving an indication of an access beam state index applicable to the symbol or slot. This two-step approach may be beneficial to minimize overhead if the number of access beams that need to be indicated by dynamic scheduling within a period is significantly smaller than the total number of access beams that the NCR supports. Such a situation is likely if the number of WTRUs actively scheduled during the period is limited.

The NCR may determine the association between an access beam and an access beam state index by receiving signaling such as a MAC CE or DCI. For example, the MAC CE or DCI may contain the identity of an access beam that is to be associated with an access beam state index, for at least one access beam and access beam state index. In case the indication is by DCI, the DCI may also indicate a resource, for example, a PUCCH resource index, for acknowledgment of reception of DCI. The association signaled by the MAC CE and the DCI may be valid until reception of a new indication associating a different access beam to the access beam index. Additionally or alternatively, the indication may be valid or applicable until expiry of a timer started upon reception of the signaling. In case no access beam is associated to an access beam state index, the WTRU may determine that a default access beam is associated to the access beam state index. Such default access beam may be pre-defined or signaled by RRC.

The NCR may in addition determine an association between an access beam state index and at least one of the following: Whether the NCR transmits or receives in an Access-Link; or a transmission power, including possibly no transmission.

The NCR may receive the indication of access beam state index applicable to a symbol or slot using RRC signaling, a MAC CE or DCI according to any solution described in this disclosure where access beam is replaced with access beam state index. For example, the NCR may receive semi-static signaling indicating a time pattern for at least one access beam state index. For example, the NCR may receive DCI indicating a set of access beam state indices applicable to a respective set of symbols, a respective set of slots, or both, where the timing of the first symbol of the set of symbols may be determined from the timing of the reception of the DCI, or last symbol thereof, and from an indication contained in the DCI or configured by higher layers.

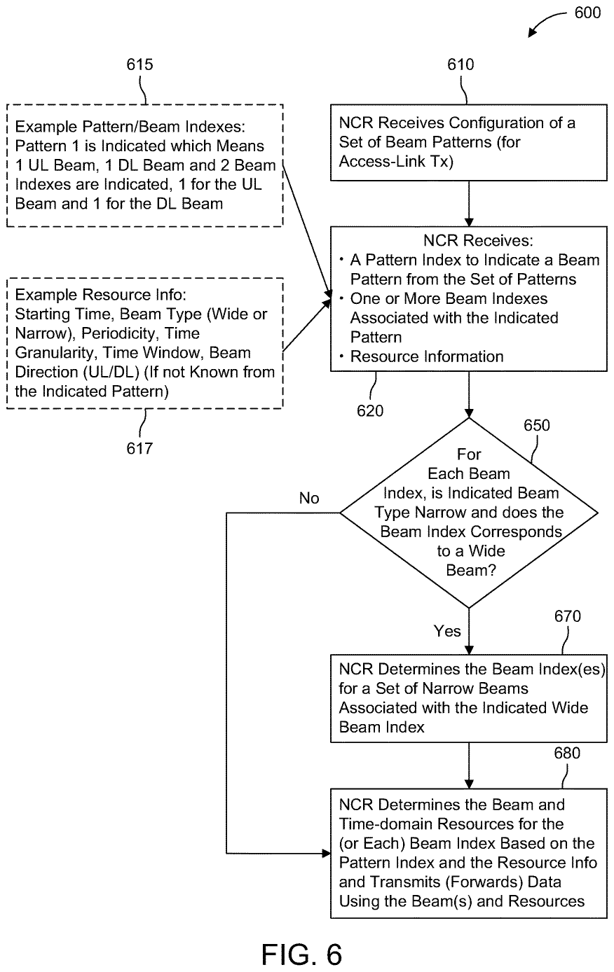

FIG. 6 is a flow chart diagram illustrating an example of a procedure for beam management for an NCR. In an example as shown in flow chart diagram 600, an NCR may receive configurations of a set of beam patterns 610. In an example, the set of beam patterns may be for an access link. Further, the NCR may receive a pattern index to indicate a beam pattern from the received set of patterns 620. Also, the NCR may receive one or more beam indexes associated with the indicated pattern. The one or more beam indexes may be received by the NCR in an indication or in multiple indications.

In an example of a pattern index, beam index or both, a pattern 1 may be indicated which includes an indication of one UL beam, one DL beam and two beam indexes 615. One of the indicated beam indexes may be for the UL beam and another of the indicated beam indexes may be for the DL beam.

Moreover, the NCR may receive resource information 620. The NCR may receive the pattern index, the one or more beam indexes and the resource information in a single indication or in multiple indications. The single indication or the multiple indications may be received by the NCR in indication information.

In an example, the received resource information may include one or more of starting time, beam type, periodicity, time granularity, time window, or beam direction 617. In an example, the beam type may be for a wide beam, a narrow beam or both. In a further example, the beam direction may be included if not known from the indicated pattern. The beam direction may be in an UL direction or in a DL direction.

Further, for each beam index, the NCR may determine if the indicated beam type is narrow and if the beam index corresponds to a wide beam 650. If NCR determines that the indicated beam type is narrow and the beam index corresponds to a wide beam, then the NCR may further determine the beam index or the beam indexes for a set of narrow beams associated with the indicated wide beam index 670.

Whether or not the NCR determines that the indicated beam type is narrow and the beam index corresponds to a wide beam, the NCR may further determine the beam and the time-domain resources for the beam index or each beam index based on the indicated pattern index and the received resource information 680. Moreover, the NCR may transmits data using the determined one or more beams and time-domain resources. In an additional or alternative example, the NCR may forward data using the determined one or more beams and time-domain resources.

In an example, the data may be DL data. For example, the DL data may be transmitted to one or more WTRUs. In an additional or alternative example, the data may be sidelink data. For example, the sidelink data may be transmitted to one or more WTRUs. In another example, the sidelink data may be forwarded to one or more WTRUs. In a further example, the sidelink data may be transmitted to another NCR. In another example, the sidelink data may be forwarded to another NCR.

In an additional or alternative example, the data may be side data. For example, the side data may be transmitted to one or more WTRUs. In another example, the side data may be forwarded to one or more WTRUs. In a further example, the side data may be transmitted to another NCR. In another example, the side data may be forwarded to another NCR.

In an additional or alternative example, the data may be UL data. For example, the UL data may be transmitted to a base station, such as a gNB. In another example, the UL may be transmitted to multiple base stations. In another example, the UL may be forwarded to one or more base stations. In an additional or alternative example, the UL data may transmitted to one or more WTRUs. In another example, the UL data may be forwarded to one or more WTRUs. In a further example, the UL data may be transmitted to another NCR. In another example, the UL data may be forwarded to another NCR.

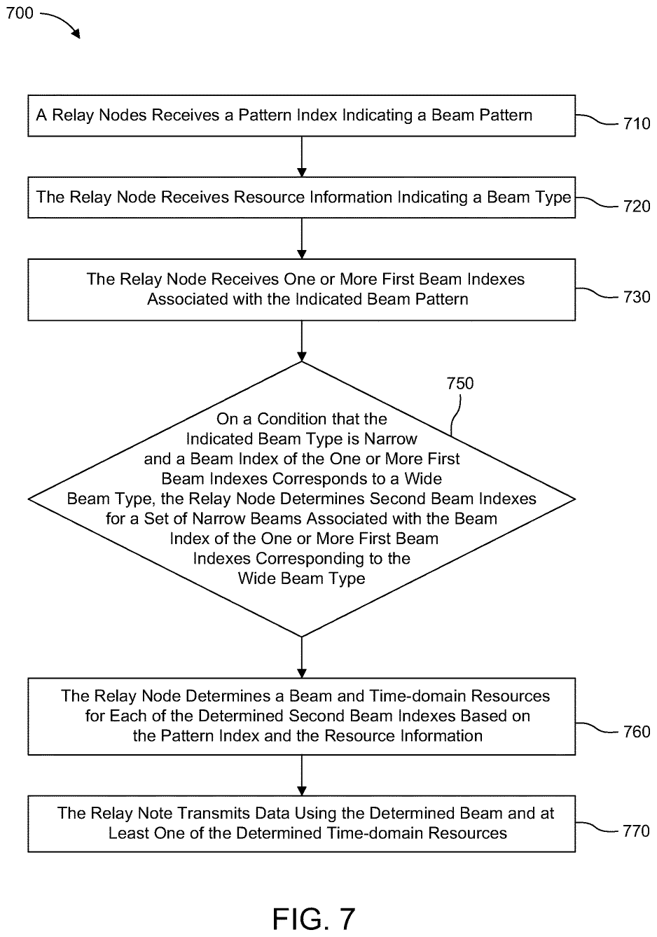

FIG. 7 a flow chart diagram illustrating an example of a procedure for beam management for a repeater node. In an example shown in flow chart diagram 700, a relay node may receive a pattern index indicating a beam pattern 710. Further, the relay node may receive resource information indicating a beam type 720. Also, the relay node may receive one or more first beam indexes associated with the indicated beam pattern 730. On a condition that the indicated beam type is narrow and a beam index of the one or more first beam indexes corresponds to a wide beam type, the relay node may determine second beam indexes for a set of narrow beams associated with the beam index of the one or more first beam indexes corresponding to the wide beam type 750. Moreover, the relay node may determine a beam and time-domain resources for each of the determined second beam indexes based on the pattern index and the resource information 760.

As a result, the relay node may transmit data using the determined beam and at least one of the determined time-domain resources 770. In an example, the data may be DL data transmitted to a wireless transmit/receive unit (WTRU). Further, the DL data may be transmitted to multiple WTRUs. In another example, the data may be transmitted over an access link. In a further example, the data may be sidelink data forwarded to the WTRU. Also, the sidelink data may be forwarded to multiple WTRUs. In an additional example, the data may be sidelink data transmitted to one or more WTRUs. In a further example, the sidelink data may be transmitted to another NCR. In another example, the sidelink data may be forwarded to another NCR.

In an additional or alternative example, the data may be side data. For example, the side data may be transmitted to one or more WTRUs. In another example, the side data may be forwarded to one or more WTRUs. In a further example, the side data may be transmitted to another NCR. In another example, the side data may be forwarded to another NCR.

In another example, the data may be UL data. For example, the UL data may be transmitted to a base station, such as a gNB. In another example, the UL may be transmitted to multiple base stations. In another example, the UL may be forwarded to one or more base stations. In an additional or alternative example, the UL data may transmitted to one or more WTRUs. In another example, the UL data may be forwarded to one or more WTRUs. In a further example, the UL data may be transmitted to another NCR. In another example, the UL data may be forwarded to another NCR.

In an additional or an alternative example, the relay node may be a first WTRU and may transmit the data to a second WTRU. In a further example, one or more of the received pattern index, the received resource information and the received first beam indexes may be received by the relay node from the base station. In a further example, the relay node may be an NCR.

In an alternative or an additional example, the relay node may be a WTRU. For example, the relay node may be a WTRU acting as an NCR. In an alternative or an additional example, the relay node may be an IAB node. For example, the relay node may be a WTRU acting as an IAB node.

In an example, the received resource information may further indicate one or more of a starting time, a periodicity, a time granularity, a time window, or a beam direction. The beam direction may be uplink or may be downlink, in examples. In a further example, the relay node may be a network-controlled relay. In another example, the relay node may be a WTRU acting as a network-controlled relay.

Embodiments and examples are provided herein of beam index and physical beams association in access-link. In an example solution, an NCR may report one or more parameters of one or more of NCR's access-link beams, for example, to a base station or gNB. In an example, the one or more parameters may be one or more physical characteristics. The NCR may receive a trigger, an indication, and/or a configuration to report respective parameters for one or more of indicated access-link beams, for example, indicated via one or more of a SIB, RRC signaling, a MAC-CE, or DCI, based on access link beam indexes. Additionally or alternatively, the NCR may determine to transmit and/or report one or more parameters for one or more of determined access-link beams, for example, due to NCR movement).

In an example solution, an NCR may report one or more of the following physical characteristics for one or more corresponding Access-Link beams: a total number of access-link beams, a total number of access-link beams with simultaneous operation, access beam types, access beam directions, or spatial relations.

Specifically, in an example, the NCR may report the total number of access-link beams. For example, the NCR may report the total number of antennas, and/or access beams. In another example, the NCR may report the total number of access beams per beam type. As such, the NCR may report a first number of total access beams for a first beam type; the NCR may report a second number of total access beams for a second beam type, and so forth.

In another example, the NCR may report the total number of access-link beams with simultaneous operation. For example, the NCR may report the total number of panels and respective number of antennas and/or access beams. In another example, the NCR may report the total number of access beams per beam type per panel. As such, the NCR may report a first number of total access beams for a first beam type and a second number of total access beams for a second beam type for a first panel, and so forth.

In a further example, the NCR may report the access beam types. For example, the NCR may report one or more beam types, wherein the beam types may be based on beamwidth, for example, wide beam or narrow beam, or the beam types may be based on the frequency ranges, for example, FR1, FR2-1, FR2-2, and so forth. As such, the NCR may report one or more access beam types that the NCR may support and based on NCR capabilities.

In an additional example, the NCR may report the access beam directions. For example, the NCR may report one or more items of information to indicate the direction of each access link beam. In an example, the NCR may report Azimuth angle, elevation angle, boresight angle, and so forth.

In yet another example, the NCR may report the spatial relations for one or more corresponding Access-Link beams: For example, the NCR may report the spatial relations between one or more access beams. The NCR may indicate the access link index and the respective spatial relation. This may enable efficient beam indication for an NCR, for example operating in multiple frequency ranges and/or characterized by different beamwidths. One or more of the following may apply, accordingly: beam hierarchy; and adjacent beams, neighboring beams or both kinds of beams.

In an example, the NCR may report information related to beam hierarchy. For example, an NCR may determine or be configured with a first and a second sets of access beams, where an access beam in the second set may be associated with at least one access beam of the first set. The access beam of the second set may be in a different frequency range, for example, a higher frequency range than the associated access beam of the first set. Additionally or alternatively, the access beam of the second set may have a different beamwidth, for example, a narrower beamwidth than the associated access beam of the first set. The association may be configured such that the NCR may operate simultaneously, for example, the NCR may one or more of receive, transmit, or forward, using an access beam of the second set and using respective associated access beam of the first set. In an example, the second set may be in a second frequency range, with a second beamwidth, or both. In another example, the first set may be in a first frequency range, with a first beamwidth, or both. More than one access beam of the second set may be associated to a same access beam of the first set.

In another example, the NCR may report information related to adjacent and/or neighboring beams. For example, an NCR may report the physical characteristics for a first access beam, where the report may include one or more indicators regarding to the access beam indexes corresponding to the beams that are adjacent to, are neighbors to, or both, the first beam, for example, in spatial domain. As such, the NCR may include neighbor access beam indexes as part of the parameters that are reported for a first access beam. The report may include the neighbor access beam indexes in a configured or preconfigured order for example, right, left, up, down, and so forth.

In an example solution, an NCR may determine, be configured, and/or be indicated to report access beam parameters, for example, physical characteristics, for a first subset of access beams as reference access beam, where the NCR may report the parameters for the other access beams relative to the determined, configured, and/or indicated reference access beams. In an example, the NCR may be configured, indicated, or determined to report one or more of the, for example, physical, parameters for a first access beam. The parameters may include the beam type, the beams' direction, spatial relations, and so forth.

For example, the NCR may indicate, may report, or both, the access beam directions based on a reference access beam. As such, the NCR may report the direction of a reference access beam for example, reporting azimuth, elevation, and/or boresight angle. Therefore, the NCR may report the direction of one or more other access beams with respect to the reference access beam, for example, a delta value based on the difference between respective azimuth, elevation, and/or boresight angles.

In another example, the NCR may indicate and/or report the spatial relation between one or more access beams relative to one or more reference access beams. As such, the NCR may derive a single-dimensional or two-dimensional array and/or table representing the array of the access beams, where the location and/or the direction of the beams may be indicated with respect to the one or more reference beams within the access beam array and/or table.

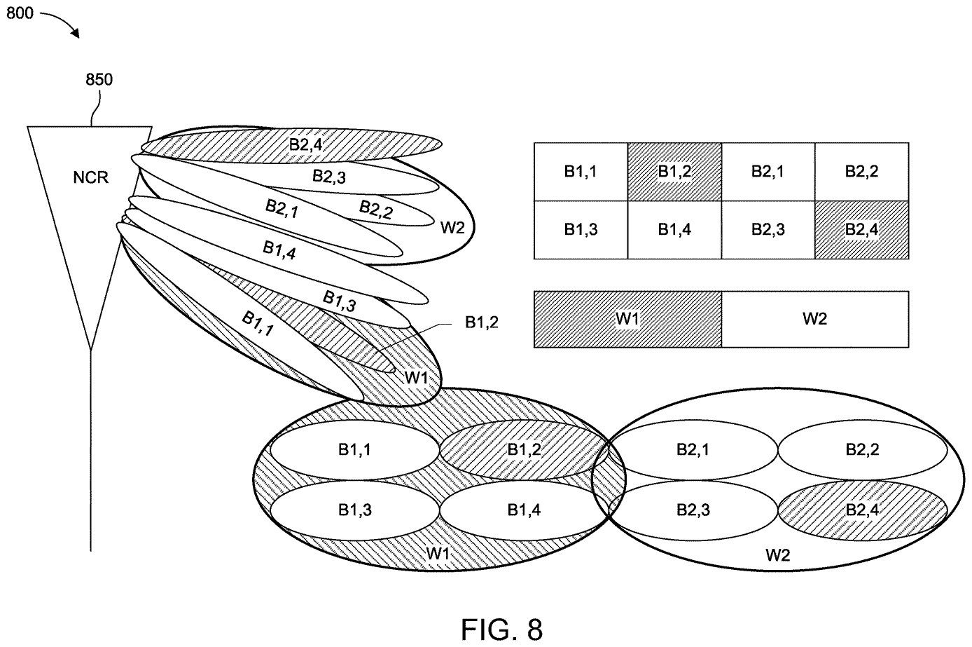

FIG. 8 is a beam pattern diagram illustrating an example of an indication of spatial relation for adjacent access beams via a table of indexes. An example in beam pattern diagram 600 shows an example of a 2×4 antenna arrays, beam arrays, or both, at the NCR Access-Link, where the physical direction of the access beams are shown as an example. Considering beams B1,2 and B2,4 as reference narrow beams and Beam W1 as the reference wide beam, the NCR 850 may define, indicate and/or report the determined values for the parameters regarding the direction or the spatial relation of the respective beams. However, the NCR 850 may not report the values for the parameters regarding the direction or the spatial relation of the other beams, wherein the NCR 850 may report the relative direction based on for example the tables provided as an example. The entries in the table, the array, or both, may represent the location, direction, the physical spatial mapping, and so forth for the indicated access beams. The NCR may report corresponding separate arrays, separate tables, or both for different beam types, as the example shown in FIG. 8.

Examples provided herein include beam determination based on beam sweeping. In an example solution, the NCR may receive one or more configurations, one or more indications, or both in order to perform beam sweeping on one or more of the access beams. The NCR may receive one or more beam patterns, for example, beam indexes, beam types, timing, and so forth, to perform the beam sweeping accordingly. In an example, the Access-Link beam sweeping means that the NCR may switch the different access beams based on a time pattern to forward one or more RSs transmitted from one or more base stations or gNBs, and/or WTRUs. As such, the NCR may determine to forward the UL and/or DL received signals and/or channels on the configured access beams based on the beam pattern. For example, the NCR may use the time pattern to switch the Access-Link beams. In an example, the NCR may switch the Access-link beams one at a time. The NCR may receive the beam sweeping indication based on one or more of the following: an explicit indication, or an implicit indication.

Specifically, the NCR may receive an explicit beam sweeping indication. For example, the NCR may receive the beam indexes to apply the beam sweeping, where one or more parameters are determined, indicated, and/or configured. The parameters may include the starting time, access beam switching time delay, access beam switching duration, periodicity, and so forth.

In another example, the NCR may receive an implicit beam sweeping indication. For example, the NCR may receive the CSI-RS resources and/or CSI-RS resource sets as part of the parameters indicated for beam sweeping, for example, beam indexes. In another example, the NCR may receive the SS/PBCH block configuration as part of the parameters configured for beam sweeping. As such, the NCR may determine the starting time, duration, periodicity, and so forth based on the timing parameters configured, the timing parameters indicated, or both, as part of CSI-RS resources configuration. The NCR may receive one or more CSI-RS resource sets for the beam sweeping, where the CSI-RS resource sets may be different for different beam types.

Examples provided herein include NCR beam suggestion and beam selection. In an example solution, an NCR may determine a first set of access beams, for example, based on one or more of direction, diversity, correlation, and may report, indicate, and/or suggest the respective access beams for example, via access beam indexes, for example, to a base station or gNB. For example, the NCR may determine the access beams based on one or more of: the direction, for example, access beams mapped to different directions; coverage, for example, access beams covering larger and/or wider coverage areas in total; diversity, for example, access beams with more diversity; or correlation, for example, access beams with lower correlation.

The base station or gNB may transmit one or more reference signals based on the first set of the access beams (e.g., suggested by NCR), wherein respective signals and/or channels may be forwarded via the NCR. The base station or gNB may further receive respective CSI reports and may determine if the suggested access beams have acceptable performance. In an example, an acceptable performance may include an RSRP, a CQI, or both higher than a threshold. In an additional or an alternative example, acceptable performance may include a Hypothetical BLER lower than a respective threshold. In case a suggested access beam's performance is in the acceptable range, the base station or gNB may use, indicate, and/or configure respective access beam at the NCR-FWD for the Access-Link. Otherwise, in case a suggested access beam's performance is not in the acceptable range, then the base station or gNB may ask, trigger, request, and/or indicate to the NCR to change respective access beam for example, dynamically, via a MAC-CE, DCI indication or both. In an example, the performance of the access beam may not be in the acceptable range due to respective WTRUs reporting one or any combination of low RSRP, low CQI, high beam failure instances, or high Hypothetical BLER.

Example provided herein include one or more of access-beam dynamic override, switching, or changing. In an example solution, an NCR may receive an indication, for example, a dynamic indication via a MAC-CE, DCI, or both, to override an access beam with a configured access beam. In an example, the access beam may be configured using a semi-static configuration received via RRC signaling. As such, the NCR may receive an indication to change a configured and/or indicated first access-link beam, for example, due to respective WTRUs reporting one or any combination of low RSRP, low CQI, high beam failure instances, or high Hypothetical BLER. In an example, the indication may include one or more second access beam indexes to override and/or substitute the first access beam. In another example, the indication may include the starting time and the time duration for which the override is applied. For example, the indication may include a reference to an event or another indication, when the override may terminate.

In an example solution, the indication may include one or more resources, patterns, events, and/or occasions, for which the overriding may take place. Additionally or alternatively, the indication may include one or more resources, patterns, events, and/or occasions, for which the overriding may not take place. In an example, the indication may include the forwarding direction that the override may take place. For example, the indication may indicate that the override may take place only for uplink, downlink, and/or both uplink and downlink transmission. In an example, overriding the second access beam may override the first access beam only for uplink, downlink, or both uplink and downlink forwarding, respectively.

In an example solution, upon reception of one or more indications on overriding a configured first access beam, the NCR may determine to use the overriding second access beam for the configurations and/or indications that were received previously, for example, before the overriding indication. For example, if the NCR is configured with a first beam pattern, for example, a semi-static configuration) to use a first access beam periodically, the NCR may use the overriding second access beam each time the first beam pattern may be applied.

In an example solution, if the overriding access beam (index) is not provided, indicated and/or configured, the NCR may determine a second access beam. For example, the NCR may determine the second access beam based on the indicated first access beam and one or more of the direction, coverage, diversity or correlation between the first and the second access beams. The NCR may report the overriding second access beam, for example, to the base station or gNB).

In an example solution, an NCR may identify, indicate, determine, or be provided, indicated, and/or configured to use one or more Access-Link beam indexes, for example, for the physical access-link beams).

In an example, the access beams may be independently indexed, where the access beam indexes may be determined, indicated, and/or configured per beam types. As such, separate and/or independent access beam indexes may be used for access beams of a same type, where the access beam indexes may be shared for different access beam types. For example, one or more of the wide access beams may be numbered and/or indexed sequentially, for example, up to a maximum number, where the first index may be determined, configured, or indicated. For example, one or more of the narrow access beams may be numbered and/or indexed sequentially, where the first index for the narrow access beams may be determined, configured, or indicated. For example, FIG. 4 shows an example of Access-Link beam indexes, where the indexes may be determined, indicated, and/or configured as {W1; W2; W3; res; res; B1,1; B1,2; B1,3; B1,4; B2;1; B2,2; B2,3; B2,4, B3,1; B3,2; B3,3; B3,4})}, where “res” implies reserved beam indexes.

In another example, the access beams may be hierarchically indexed, where the hierarchical access beam indexes may be determined, indicated, and/or configured based on different beam types. As such, each wide access beam index may be followed with one or more narrow access beam indexes, where the narrow access beams may be associated with the wide access beam. For example, FIG. 4 shows an example of Access-Link beam indexes, where the indexes may be determined, indicated, and/or configured as {W1; B1,1; B1,2; B1,3; B1,4; W2; B2;1; B2,2; B2,3; B2,4; W3; B3,1; B3,2; B3,3; B3,4})}.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, STA, AP, relay node, mesh node, customer premises equipment (CPE), fixed wireless access (FWA) device, industrial device, TRP, M-TRP, vehicle, drone or any host computer.

1. A method for use in a relay node, the method comprising:
receiving a pattern index, wherein the pattern index indicates a beam pattern;
receiving resource information, wherein the resource information indicates a beam type;
receiving one or more first beam indexes associated with the indicated beam pattern;
on a condition that the indicated beam type is narrow and a beam index of the one or more first beam indexes corresponds to a wide beam type, determining second beam indexes for a set of narrow beams associated with the beam index of the one or more first beam indexes corresponding to the wide beam type;
determining a beam and time-domain resources for each of the determined second beam indexes based on the pattern index and the resource information; and
transmitting data using at least one of the determined beams and at least one of the determined time-domain resources.

2. The method of claim 1, wherein the relay node is a network-controlled repeater (NCR).

3. The method of claim 1, wherein the relay node is a first wireless transmit/receive unit (WTRU).

4. The method of claim 1, wherein the resource information further indicates one or more of a starting time, a periodicity, a time granularity, a time window, or a beam direction.

5. The method of claim 1, wherein the data is transmitted over an access link.

6. The method of claim 1, wherein the data is downlink (DL) data transmitted to a second WTRU.

7. The method of claim 1, wherein the data is sidelink data.

8. The method of claim 1, wherein the data is side data.

9. The method of claim 1, wherein the data is uplink (UL) data transmitted to a base station.

10. The method of claim 9, wherein one or more of the pattern index, resource information, or one or more first beam indexes are received from the base station.

11. A relay node comprising:
a transceiver; and
a processor operatively coupled to the transceiver; wherein:
the transceiver is configured to receive a pattern index, wherein the pattern index indicates a beam pattern;
the transceiver is configured to receive resource information, wherein the resource information indicates a beam type;
the transceiver is configured to receive one or more first beam indexes associated with the indicated beam pattern;
the processor is configured to determine, on a condition that the indicated beam type is narrow and a beam index of the one or more first beam indexes corresponds to a wide beam type, second beam indexes for a set of narrow beams associated with the beam index of the one or more first beam indexes corresponding to the wide beam type;
the processor is configured to determine a beam and time-domain resources for each of the determined second beam indexes based on the pattern index and the resource information; and
the transceiver is configured to transmit data using at least one of the determined beams and at least one of the determined time-domain resources.

12. The relay node of claim 11, wherein the relay node is a network-controlled repeater (NCR).

13. The relay node of claim 11, wherein the relay node is a first wireless transmit/receive unit (WTRU).

14. The relay node of claim 11, wherein the resource information further indicates one or more of a starting time, a periodicity, a time granularity, a time window, or a beam direction.

15. The relay node of claim 11, wherein the data is transmitted over an access link.

16. The relay node of claim 11, wherein the data is downlink (DL) data transmitted to a second WTRU.

17. The relay node of claim 11, wherein the data is sidelink data.

18. The relay node of claim 11, wherein the data is side data.

19. The relay node of claim 11, wherein the data is uplink (UL) data transmitted to a base station.

20. The relay node of claim 19, wherein one or more of the pattern index, resource information, or one or more first beam indexes are received from the base station.
